(19) United States
(12) Patent Application Publication
(10) Pub. No.: US 2025/0187626 A1
(43) Pub. Date: Jun. 12, 2025

(54) APPARATUS FOR CONTROLLING AUTONOMOUS DRIVING AND METHOD THEREOF

(71) Applicants: HYUNDAI MOTOR COMPANY, Seoul (KR); Kia Corporation, Seoul (KR); HYUNDAI AUTOEVER Corp., Seoul (KR)

(72) Inventors: Yu Ho CHOI, Seoul (KR); Jang Soon HAN, Seoul (KR); Kyung Taek KIM, Anyang-si (KR)

(73) Assignees: HYUNDAI MOTOR COMPANY, Seoul (KR); Kia Corporation, Seoul (KR); HYUNDAI AUTOEVER Corp., Seoul (KR)

(21) Appl. No.: 18/761,858

(22) Filed: Jul. 2, 2024

(30) Foreign Application Priority Data
Dec. 8, 2023 (KR) 10-2023-0178073

(51) Int. Cl. B60W 60/00; B60W 50/00

(52) U.S. Cl. CPC B60W 60/001; B60W 2050/0005

(57) ABSTRACT

An autonomous driving control apparatus may include a memory, and a control device. For example, the autonomous driving control apparatus may collect pieces of data regarding autonomous driving control of a host vehicle, may store first data, which is collected during a first period and which corresponds to a first trigger signal, in a first buffer among the at least one buffer, and may store, in a second buffer among the at least one buffer, second data of a second period corresponding to a second trigger signal identified at a time point within the first period.

### CROSS-REFERENCE TO RELATED APPLICATION

The present application claims priority to Korean Patent Application No. 10-2023-0178073, filed on Dec. 8, 2023, the entire contents of which is incorporated herein for all purposes by this reference.

### BACKGROUND OF THE PRESENT DISCLOSURE

### Field of the Present Disclosure

The present disclosure relates to an autonomous driving control apparatus and a method thereof, and more specifically, relates to a technology for efficiently storing pieces of data identified while a host vehicle is driving.

### Description of Related Art

As autonomous driving vehicles are gradually spread, various technologies related to autonomous driving are being developed. For example, more and more data may be needed for stable driving of autonomous vehicles. Accordingly, technologies need to be developed to efficiently store and manage data.

For example, in accordance with established laws and regulations, an autonomous driving control apparatus needs to store at least part of pieces of data, which is generated (or identified) while performing autonomous driving control on a host vehicle, in a memory.

However, with the development of an autonomous driving technology, the size or storage time of data to be stored by an autonomous driving control apparatus may gradually increase. Furthermore, if a limit situation occurs such as a situation where data needs to be stored continuously (e.g., a situation where triggers for storing data are continuously identified) or a situation where the autonomous driving control apparatus is reset, a method in which an autonomous driving control apparatus efficiently stores and manages driving data may be required.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an autonomous driving control apparatus which may sequentially store and manage data in at least one buffer included in a memory if data is continuously collected in a process of storing data regarding the driving of a host vehicle in the memory.

Various aspects of the present disclosure are directed to providing an autonomous driving control apparatus which may store first data among pieces of data in a first buffer, may exclude redundant data collected during a period that overlaps a first period corresponding to the first data, and may store (or update) only new data corresponding to the non-overlapping period in a second buffer.

Embodiments of the present disclosure, an autonomous driving control apparatus may store the first data, which is stored based on a first thread in the first buffer, in the storage device in response that the first trigger is identified. Various aspects of the present disclosure are directed to providing an autonomous driving control apparatus which may update, based on a second thread distinct from the first thread, new data, which is stored in the second buffer, in the storage device if a second trigger is identified.

Various aspects of the present disclosure are directed to providing an autonomous driving control apparatus which may store a RAM file system corresponding to new data in a buffer. Various aspects of the present disclosure are directed to providing an autonomous driving control apparatus which may copy the RAM file system to the storage device in response of identifying the second trigger signal.

Various aspects of the present disclosure are directed to providing an autonomous driving control apparatus which may rapidly copy at least part of data related to a trigger signal among pieces of data temporarily stored in the buffer to a storage device (e.g., embedded Multi-Media Card (eMMC)).

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, an autonomous driving control apparatus may include a memory that stores instructions and includes at least one buffer and a storage device, and a control device operatively connected to the memory. For example, if executed by the control device, the instructions may cause the autonomous driving control apparatus to collect pieces of data regarding autonomous driving control of a host vehicle, to store first data, which is collected during a first period and which corresponds to a first trigger signal, in a first buffer among the at least one buffer, and to store, in a second buffer among the at least one buffer, second data of a second period corresponding to a second trigger signal identified at a time point within the first period.

According to an exemplary embodiment of the present disclosure, if executed by the control device, the instructions may cause the autonomous driving control apparatus to collect the pieces of data including the first data and the second data while performing the autonomous driving control on the host vehicle in a predetermined driving section.

According to an exemplary embodiment of the present disclosure, if executed by the control device, the instructions may cause the autonomous driving control apparatus to store the second data of the second period in the storage device, which is included in the memory and is separate from the at least one buffer, in response that the second trigger signal is identified.

According to an exemplary embodiment of the present disclosure, the storage device may include an embedded Multi-Media Card (eMMC).

According to an exemplary embodiment of the present disclosure, if executed by the control device, the instructions may cause the autonomous driving control apparatus to update, in the second buffer, new data corresponding to a third period, which does not overlap the first period, in the second period from among the second data of the second period.

According to an exemplary embodiment of the present disclosure, if executed by the control device, the instructions may cause the autonomous driving control apparatus to store, based on a first thread, the first data, which is stored in the first buffer, in the storage device in response that the first trigger is identified, and to update, based on a second thread distinct from the first thread, the new data, which is stored in the second buffer, in the storage device in response that the second trigger is identified.

According to an exemplary embodiment of the present disclosure, if executed by the control device, the instructions may cause the autonomous driving control apparatus to store a RAM file system corresponding to the new data in the buffer, and to copy the RAM file system to the storage device in response of identifying the second trigger signal. For example, the RAM file system may include at least one of driving data of the host vehicle corresponding to the third period among the second data, or time information related to the third period, or any combination thereof.

According to an exemplary embodiment of the present disclosure, if executed by the control device, the instructions may cause the autonomous driving control apparatus to store predetermined data corresponding to a pre-defined event among the pieces of data in the storage device in response of identifying that the pre-defined event occurs while the pieces of data are collected.

According to an exemplary embodiment of the present disclosure, the pre-defined event may include at least one of activation or deactivation of at least part of an autonomous driving system of the host vehicle including the autonomous driving control apparatus, occurrence of a situation of at least one of transition demand (TD), minimum risk maneuver (MRM), or emergency maneuver (EM), or any combination thereof, data update of an event data recorder (EDR), or occurrence of performance deterioration or failure of the host vehicle, or any combination thereof.

According to an exemplary embodiment of the present disclosure, if executed by the control device, the instructions may cause the autonomous driving control apparatus to encrypt at least one of location information of the host vehicle, or user information, or any combination thereof among the pieces of data and then to store the encrypted result in the memory.

According to an aspect of the present disclosure, an autonomous driving control method may include collecting, by a control device, pieces of data regarding autonomous driving control of a host vehicle, storing, by the control device, first data, which is collected during a first period and which corresponds to a first trigger signal, in a first buffer among at least one buffer, and storing, by the control device, second data of a second period corresponding to a second trigger signal identified at a time point within the first period in a second buffer among the at least one buffer.

According to an exemplary embodiment of the present disclosure, the autonomous driving control method may further include collecting, by the control device, the pieces of data including the first data and the second data while performing the autonomous driving control on the host vehicle in a predetermined driving section.

According to an exemplary embodiment of the present disclosure, the autonomous driving control method may further include storing, by the control device, the second data of the second period in a storage device, which is included in a memory and is separate from the at least one buffer, in response that the second trigger signal is identified.

According to an exemplary embodiment of the present disclosure, the storage device may include an eMMC.

According to an exemplary embodiment of the present disclosure, the autonomous driving control method may further include updating, by the control device, new data corresponding to a third period, which does not overlap the first period, in the second period from among the second data of the second period in the second buffer.

According to an exemplary embodiment of the present disclosure, the autonomous driving control method may further include storing, based on a first thread, the first data, which is stored in the first buffer, in the storage device by the control device in response that the first trigger is identified, and updating, based on a second thread distinct from the first thread, the new data, which is stored in the second buffer, in the storage device by the control device in response that the second trigger is identified.

According to an exemplary embodiment of the present disclosure, the autonomous driving control method may further include storing, by the control device, a RAM file system corresponding to the new data in the buffer, and copying, by the control device, the RAM file system to the storage device in response of identifying the second trigger signal. For example, the RAM file system may include at least one of driving data of the host vehicle corresponding to the third period among the second data, or time information related to the third period, or any combination thereof.

According to an exemplary embodiment of the present disclosure, the autonomous driving control method may further include storing, by the control device, predetermined data corresponding to a pre-defined event among the pieces of data in the storage device in response of identifying that the pre-defined event occurs while the pieces of data are collected.

According to an exemplary embodiment of the present disclosure, the pre-defined event may include at least one of activation or deactivation of at least part of an autonomous driving system of the host vehicle including an autonomous driving control apparatus, occurrence of a situation of at least one of TD, MRM, or EM, or any combination thereof, data update of an EDR, or occurrence of performance deterioration or failure of the host vehicle, or any combination thereof.

According to an exemplary embodiment of the present disclosure, the autonomous driving control method may further include encrypting, by the control device, at least one of location information of the host vehicle, or user information, or any combination thereof among the pieces of data and then storing the encrypted result in a memory.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram showing components of an autonomous driving control apparatus, according to an exemplary embodiment of the present disclosure;

FIG. 2 is a conceptual diagram showing components and operations of an autonomous driving control apparatus, according to an exemplary embodiment of the present disclosure;

FIG. 3 is a conceptual diagram illustrating data stored by an autonomous driving control apparatus, according to an exemplary embodiment of the present disclosure;

FIG. 4 is a conceptual diagram of operations of an autonomous driving control method, according to an exemplary embodiment of the present disclosure;

FIG. 5 is a conceptual diagram illustrating data stored by an autonomous driving control apparatus, according to an exemplary embodiment of the present disclosure;

FIG. 6 is a conceptual diagram of operations of an autonomous driving control method, according to an exemplary embodiment of the present disclosure;

FIG. 7 is a table illustrating criteria used as an autonomous driving control apparatus utilizes an additional buffer, according to an exemplary embodiment of the present disclosure;

FIG. 8 is a block diagram showing components of an autonomous driving control apparatus, according to an exemplary embodiment of the present disclosure;

FIG. 9 is a flowchart of an autonomous driving control method, according to an exemplary embodiment of the present disclosure; and

FIG. 10 shows a computing system related to an autonomous driving control apparatus or autonomous driving control method, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to components of each drawing, it should be noted that the same components include the same reference numerals, although they are indicated on another drawing. Furthermore, in describing the exemplary embodiments of the present disclosure, detailed descriptions associated with well-known functions or configurations will be omitted if they may make subject matters of the present disclosure unnecessarily obscure.

In describing elements of an exemplary embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as including a meaning which is consistent with their meaning in the context of the present disclosure and the relevant art and will not be interpreted in an idealized or overly formal sense unless expressly so defined herein.

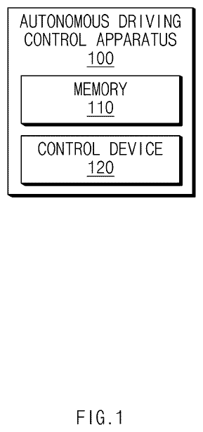

Hereinafter, various embodiments of the present disclosure will be described in detail with reference to FIGS. 1 to 10.

FIG. 1 is a block diagram showing components of an autonomous driving control apparatus, according to an exemplary embodiment of the present disclosure.

According to an exemplary embodiment of the present disclosure, an autonomous driving control apparatus 100 may include a memory 110 and a control device 120. The configuration of the autonomous driving control apparatus 100 shown in FIG. 1 is an example, and embodiments of the present disclosure are not limited thereto. For example, the autonomous driving control apparatus 100 may further include components not shown in FIG. 1 (e.g., at least one of a sensor device, a communication device, an interface device, a display device, or a notification device, or any combination thereof).

According to an exemplary embodiment of the present disclosure, the memory 110 may store instructions or data. For example, the memory 110 may store one or more instructions that cause the autonomous driving control apparatus 100 to perform various operations if executed by the control device 120.

For example, the memory 110 and the control device 120 may be implemented as one chipset. The control device 120 may include at least one of a communication processor or a modem.

For example, the memory 110 may store various pieces of information related to the autonomous driving control apparatus 100. For example, the memory 110 may store information related to the operation history of the control device 120. For example, the memory 110 may store information related to states and/or operations of components (e.g., at least one of an engine control unit (ECU), a sensor device, a driving device, the memory 110, an input device, or a notification device, or any combination thereof) of a host vehicle.

For example, the memory 110 may include different types of storage devices. For example, the memory 110 may include at least one of a random-access memory (RAM), or an embedded multi-media card (eMMC), or any combination thereof.

For example, the RAM may temporarily (or transiently) store data (e.g., driving data) regarding the operation of the autonomous driving control apparatus 100 and/or the host vehicle to be controlled by the autonomous driving control apparatus 100. For example, the RAM may include at least one buffer.

For example, the autonomous driving control apparatus 100 may store, in a RAM, at least one node obtained based on dividing pieces of data, which are collected (or identified) while autonomous driving control is performed on the host vehicle, based on unit times.

For example, the eMMC may include an embedded multimedia card. For example, the eMMC may store data for a longer period of time than the RAM. For example, the eMMC may be implemented as a separate memory chip separate from the RAM.

According to an exemplary embodiment of the present disclosure, the control device 120 may be operatively connected to the memory 110. For example, the control device 120 may be configured for controlling the operation of the memory 110.

For example, the control device 120 may collect pieces of data regarding autonomous driving control of the host vehicle.

For example, the control device 120 may collect (or obtain) various pieces of data generated (or identified) while autonomous driving control is performed on the host vehicle.

For example, the pieces of data related to the autonomous driving control may include driving data related to the driving of the host vehicle. For example, the driving data may include information related to at least one of the host vehicle's driving environment, driving speed, or event occurring while driving, or any combination thereof.

For example, the control device 120 may temporarily store, in a buffer included in the memory 110, at least part of pieces of data collected while autonomous driving control is performed on the host vehicle in a specified driving section (e.g., a highway).

For example, the control device 120 may store, in a first buffer among at least one buffer, first data which is collected during a first period and which corresponds to a first trigger signal.

For example, the first period may be defined as a period including a period earlier than a time point, at which the first trigger signal occurs, by 30 seconds and a period later than a time point, at which the first trigger signal occurs, by 30 seconds.

For example, the control device 120 may store, in a second buffer among at least one buffer, second data of a second period corresponding to a second trigger signal identified at a time point within the first period.

For example, the second period may be defined as a period including a period earlier than a time point, at which the second trigger signal occurs, by 30 seconds and a period later than a time point, at which the second trigger signal occurs, by 30 seconds.

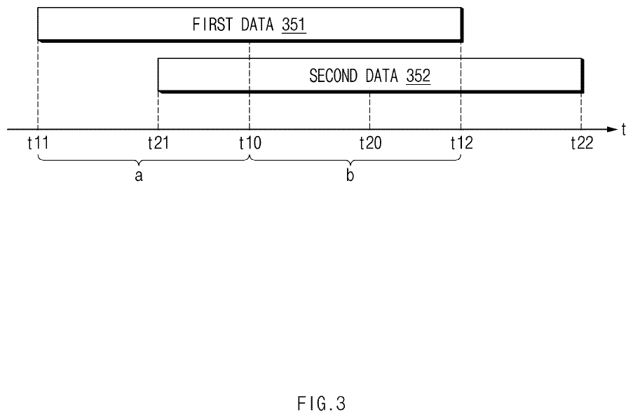

For example, the first period and the second period may at least partially overlap each other. The description of the overlapped period may be replaced with the description of FIG. 3, which will be described later.

For example, the control device 120 may implement at least part of the collected pieces of data as a RAM file system and may store the RAM file system in at least one buffer and/or a storage device (e.g., eMMC).

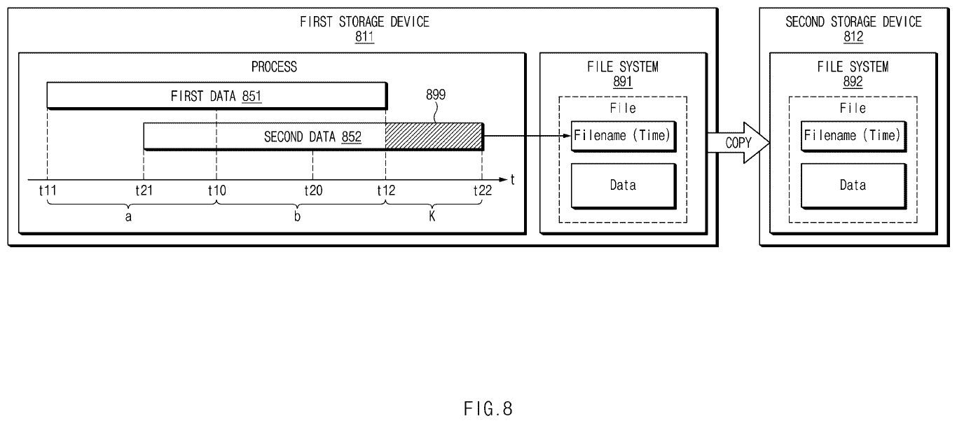

The description of the structure of the RAM file system may be replaced with the description of FIG. 8, which will be described later.

For example, the control device 120 may collect pieces of data including the first data and the second data, which are generated while autonomous driving control is performed on the host vehicle in a specified driving section.

For example, the specified driving section may include a highway.

For example, if the first trigger signal is identified, the control device 120 may store, in the storage device, the second data of the first period.

For example, the first period may include a period earlier than a time point, at which the first trigger signal is identified, by a specified time (e.g., 30 seconds) and a period later than a time point, at which the first trigger signal is identified, by a specified time (e.g., 30 seconds).

For example, if the second trigger signal is identified, the control device 120 may store, in the storage device, the second data of the second period.

For example, the second period may include a period earlier than a time point, at which the second trigger signal is identified, by a specified time (e.g., 30 seconds) and a period later than a time point, at which the second trigger signal is identified, by a specified time (e.g., 30 seconds).

For example, the storage device may be a separate storage device, which is included in the memory 110 and which is distinct from at least one buffer.

For example, the control device 120 may update, in the second buffer, new data corresponding to a third period, which does not overlap the first period, in the second period among the second data of the second period.

For example, if the first trigger is identified, the control device 120 may store, based on a first thread, the first data, which is stored in the first buffer, in the storage device.

For example, if the second trigger is identified, the control device 120 may store (or update), based on a second thread distinct from the first thread, new data stored in the second buffer in the storage device.

In other words, the control device 120 may move and store pieces of data stored in each of a plurality of buffers to the storage device based on multi-threads.

For example, the control device 120 may store a RAM file system corresponding to new data in the buffer.

For example, the RAM file system may include at least one of driving data of the host vehicle corresponding to the third period, or time information related to a third period, or any combination thereof among the second data.

For example, if identifying the second trigger signal, the control device 120 may copy the RAM file system to the storage device.

For example, if the control device 120 identifies that a pre-defined event occurs while collecting pieces of data, the control device 120 may store specified data corresponding to the pre-defined event among pieces of data in the storage device.

For example, the pre-defined event may include at least one of activation or deactivation of at least part of the autonomous driving system of the host vehicle including the autonomous driving control apparatus, occurrence of a situation of at least one of transition demand (TD), minimum risk maneuver (MRM), or emergency maneuver (EM), or any combination thereof, data update of an event data recorder (EDR), or occurrence of performance deterioration or failure of the host vehicle, or any combination thereof.

For example, if the control device 120 identifies that the pre-defined event occurs while collecting pieces of data, the control device 120 may store specified data corresponding to the pre-defined event among pieces of data in the storage device without going through a buffer (or before going through a buffer).

For example, the pre-defined event may include at least one of an event predefined by a developer, an event defined by a user's settings, or an event defined by law, or any combination thereof.

For example, the pre-defined event may include the activation or deactivation of at least part of the autonomous driving system of the host vehicle including the autonomous driving control apparatus 100. In other words, if at least part of devices (e.g., the autonomous driving control apparatus 100) included in the autonomous driving system of the host vehicle is activated or deactivated, the autonomous driving control apparatus 100 may identify that the pre-defined event occurs, and may directly store data corresponding to the pre-defined event in the storage device without going through the buffer (or before going through the buffer).

For example, the pre-defined event may include the activation or deactivation of at least part of the autonomous driving system of the host vehicle including the autonomous driving control apparatus 100. In other words, if at least part of devices (e.g., the autonomous driving control apparatus 100) included in the autonomous driving system of the host vehicle is activated or deactivated, the autonomous driving control apparatus 100 may identify that the pre-defined event occurs, and may directly store data corresponding to the pre-defined event in the storage device without going through the buffer (or before going through the buffer).

For example, the pre-defined event may include a situation of at least one of TD, MRM, or EM, or any combination thereof. In other words, if the TD, MRM, and/or EM situation occurs in a process of performing autonomous driving control on the host vehicle, the autonomous driving control apparatus 100 may identify that the pre-defined event occurs, and may directly store data corresponding to the pre-defined event in the storage device without going through the buffer (or before going through the buffer).

For example, the pre-defined event may include a situation in which data in an event data recorder (EDR) is updated. In other words, if it is identified that data is updated in EDR for storing a part (e.g., accident data) of data generated in a process of performing autonomous driving control on the host vehicle, the autonomous driving control apparatus 100 may identify that the pre-defined event occurs, and may directly store data corresponding to the pre-defined event in a storage device without going through the buffer (or before going through the buffer).

For example, the pre-defined event may include situations where the performance of the host vehicle deteriorates or a breakdown occurs. In other words, if it is identified that the driving performance of the host vehicle falls so that the driving performance of the host vehicle is smaller than a predefined performance, or a part of components of the host vehicle fails, the autonomous driving control apparatus 100 may identify that the pre-defined event occurs, and may directly store data corresponding to the pre-defined event in a storage device without going through the buffer (or before going through the buffer).

For example, if a plurality of trigger signals continuously occur, the control device 120 may sequentially store pieces of data corresponding to each trigger signal in the storage device.

For example, the control device 120 may store first data of the first period in the buffer based on a first time point at which a first trigger signal among at least one trigger signal is identified.

For example, the control device 120 may store second data of the second period in the buffer based on a second time point at which a second trigger signal among at least one trigger signal is identified. For example, the second time point may be a time point after the first time point.

For example, the control device 120 may respectively store first driving data and second driving data corresponding to the first period and the second period among pieces of data stored in the buffer in a storage device. Through the present process, the control device 120 may temporarily store the first data and the second data, which need to be stored in the buffer and may then copy (or store) the first data and the second data to a storage device. Accordingly, the control device 120 may sequentially store the corresponding data in the storage device for a relatively long period depending on the storage order.

For example, the control device 120 may encrypt pieces of data related to personal information before storing the pieces of data in the memory 110.

For example, the control device 120 may encrypt at least one of location information of the host vehicle among driving data, or user information, or any combination thereof and may store the encrypted data in the memory 110.

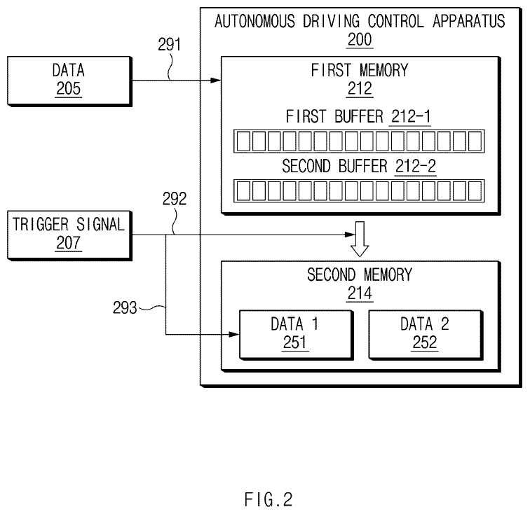

FIG. 2 is a conceptual diagram showing components and operations of an autonomous driving control apparatus, according to an exemplary embodiment of the present disclosure.

According to an exemplary embodiment of the present disclosure, an autonomous driving control apparatus 200 (e.g., the autonomous driving control apparatus 100 in FIG. 1) may include a first memory 212 (e.g., RAM) and a second memory 214 (e.g., eMMC). For example, the first memory 212 and the second memory 214 may be implemented as one device (e.g., the memory 110 in FIG. 1). For example, the first memory 212 and the second memory 214 may be operatively connected to a control device (e.g., the control device 120 of FIG. 1). For example, the first memory 212 and the second memory 214 may be electrically connected to each other to exchange data with each other.

For example, the first memory 212 may include at least one buffer 212-1 or 212-2.

For example, the first memory 212 may include the first buffer 212-1 and the second buffer 212-2.

Referring to reference number 291, according to an exemplary embodiment of the present disclosure, the autonomous driving control apparatus 200 may sequentially store data 205 generated (or obtained) while performing autonomous driving control on the host vehicle in at least one buffer included in the first memory 212.

For example, the second memory 214 may include a storage space and/or a controller for storing data. For example, the second memory 214 may be eMMC.

Referring to reference numbers 292 and 293, according to an exemplary embodiment of the present disclosure, the autonomous driving control apparatus 200 may identify (or detect) a trigger signal 207. If the trigger signal 207 is detected, the autonomous driving control apparatus 200 may store data in the second memory 214 in different ways depending on the type of a trigger signal.

Referring to the reference number 292, for example, if the trigger signal 207 is identified, the autonomous driving control apparatus 200 may store, in the second memory 214, data 2 252 corresponding to the trigger signal 207 among pieces of data stored in at least one buffer 212-1 or 212-2.

For example, the autonomous driving control apparatus 200 may move and store the data 2 252 corresponding to a specified period identified based on a time point, at which the trigger signal 207 is identified (or occurred), from the at least one buffer 212-1 or 212-2 to the second memory 214.

Referring to a reference number 293, for example, if the trigger signal 207 corresponds to a pre-defined event, the autonomous driving control apparatus 200 may store data 1 251 regarding the corresponding event directly in the second memory 214 without going through the first memory 212 (or the at least one buffer 212-1 or 212-2).

FIG. 3 is a conceptual diagram illustrating data stored by an autonomous driving control apparatus, according to an exemplary embodiment of the present disclosure.

Referring to FIG. 3, according to an exemplary embodiment of the present disclosure, an autonomous driving control apparatus (e.g., the autonomous driving control apparatus 100 in FIG. 1) may temporarily store data 351 or 352 related to autonomous driving control in at least one buffer (e.g., the first buffer 212-1 and/or the second buffer 212-2 in FIG. 2).

For example, if determining whether a trigger signal occurs, the autonomous driving control apparatus may store some of pieces of data temporarily stored in at least one buffer in a storage device (e.g., the second memory 214 in FIG. 2) separate from the at least one buffer.

For example, the autonomous driving control apparatus may identify that a first trigger signal occurred at a first time point t10. The autonomous driving control apparatus may identify a 1-1st time point t11 earlier than the first time point t10 by time ‘a’ (e.g., 30 seconds), and may identify a 1-2nd time point t12 later than the first time point t10 by time ‘b’ (e.g., 30 seconds). The autonomous driving control apparatus may identify a period from the 1-1st time point t11 to the 1-2nd time point t12 as a first period corresponding to the first trigger signal.

For example, the autonomous driving control apparatus may store first data 351, which is autonomous driving data of a host vehicle during the first period, in a storage device based on the fact the first trigger signal is identified. In the instant case, the autonomous driving control apparatus may store data corresponding to the first data 351 in a storage device (e.g., eMMC) of a memory separate from the buffer from among other various pieces of data temporarily stored in the buffer.

In the present situation, the autonomous driving control apparatus may identify that a second trigger signal occurred at a second time point t20. The autonomous driving control apparatus may identify a 2-1st time point t21 earlier than the second time point t20 by time ‘a’ (e.g., 30 seconds), and may identify a 2-2nd time point t22 later than the second time point t20 by time ‘b’ (e.g., 30 seconds). The autonomous driving control apparatus may identify a period from the 2-1st time point t21 to the 2-2nd time point t22 as a second period corresponding to the second trigger signal.

For example, the autonomous driving control apparatus may store second data 352, which is autonomous driving data of a host vehicle during the second period, in a memory based on the fact the second trigger signal is identified. However, there is some overlapping period (e.g., the period from the 2-1st time point t21 to the 1-2nd time point t12) between the second period corresponding to the second data 352 and the first period corresponding to the first data 351.

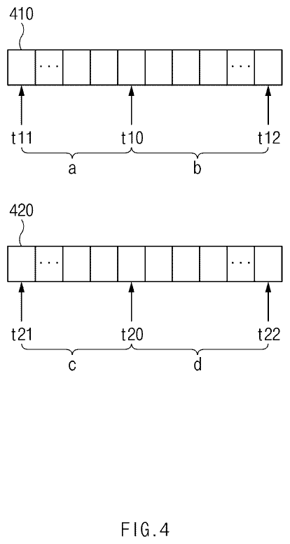

Accordingly, if the autonomous driving control apparatus is implemented to include a single buffer, there may be limitations in rapidly storing the corresponding pieces of data. To solve these issues, the autonomous driving control apparatus according to an exemplary embodiment of the present disclosure may store data based on an algorithm of FIG. 4 below.

FIG. 4 is a conceptual diagram of operations of an autonomous driving control method, according to an exemplary embodiment of the present disclosure.

According to an exemplary embodiment of the present disclosure, an autonomous driving control apparatus may sequentially store, based on at least one buffer 410 or 420, pieces of data related to autonomous driving control of a host vehicle. If a plurality of trigger signals are identified, the autonomous driving control apparatus may transmit (or copy) the pieces of sequentially stored data to a storage device in a memory separated from the at least one buffer 410 or 420.

For example, the autonomous driving control apparatus may store first data in the first buffer 410.

For example, the autonomous driving control apparatus may store second data in the second buffer 420.

For example, the autonomous driving control apparatus may identify that the first trigger signal occurred at the first time point t10 in a first period corresponding to the first data. The autonomous driving control apparatus may identify a 1-1st time point t11 earlier than the first time point t10 by time ‘a’ (e.g., 30 seconds), and may identify a 1-2nd time point t12 later than the first time point t10 by time ‘b’ (e.g., 30 seconds). The autonomous driving control apparatus may identify a period from the 1-1st time point t11 to the 1-2nd time point t12 as a first period corresponding to the first trigger signal.

For example, the autonomous driving control apparatus may store driving data, which is stored during the first period among pieces of data stored in the first buffer 410, in a storage device (e.g., eMMC) based on the first trigger signal being identified. In the instant case, the autonomous driving control apparatus may store data, which corresponds to the first period, from among other various pieces of data temporarily stored in the first buffer 410 in a memory storage device (e.g., eMMC).

In the present situation, the autonomous driving control apparatus may identify that a second trigger signal occurred at a second time point t20. For example, the second time point t20 may be a time point after the first time point t10. The autonomous driving control apparatus may identify a 2-1st time point t21 earlier than the second time point t20 by time ‘c’ (e.g., 30 seconds), and may identify the 2-2nd time point t22 later than the second time point t20 by time ‘d’ (e.g., 10 seconds) and time ‘e’ (e.g., 20 seconds). The autonomous driving control apparatus may identify a period from the 2-1st time point t21 to the 2-2nd time point t22 as a second period corresponding to the second trigger signal.

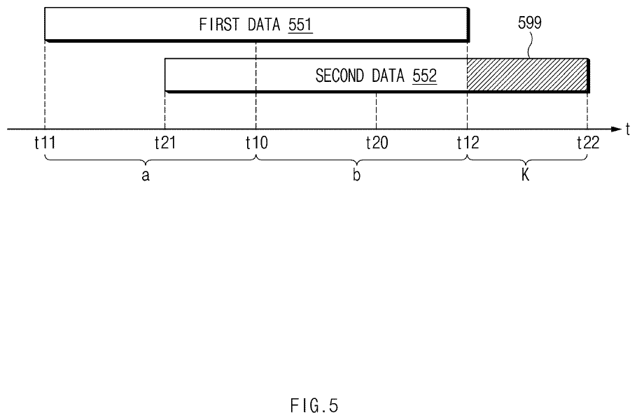

For example, there may be overlapping periods between the first period and the second period. For example, the period between the 2-1st time point t21 and the 1-2nd time point t12 may be an overlapping period. A data processing method corresponding to an overlapping period will be described with reference to FIG. 5 below.

FIG. 5 is a conceptual diagram illustrating data stored by an autonomous driving control apparatus, according to an exemplary embodiment of the present disclosure.

According to an exemplary embodiment of the present disclosure, an autonomous driving control apparatus (e.g., the autonomous driving control apparatus in FIG. 1) may not store redundant data among first data 551 stored in a first buffer, and second data 552 stored in a second buffer to a storage device.

For example, the autonomous driving control apparatus may store, in the first buffer, the first data 551 collected during the first period from the 1-1st time point t11 to the 1-2nd time point t12.

For example, the autonomous driving control apparatus may store, in the second buffer, the second data 552 collected during the second period from the 2-1st time point t21 to the 2-2nd time point t22.

For example, there may be overlapping periods between periods in which the first data 551 and the second data 552 are collected. Referring to FIG. 5, a period from the 2-1st time point t21 to the 1-2nd time point t12 may correspond to the overlapping period. Accordingly, the first data 551 and the second data 552 corresponding to the corresponding periods are the same as each other, and thus there may be no need to store the first data 551 and the second data 552 redundantly in the storage device.

Accordingly, if the second trigger signal is identified in a process of storing the second data 552 in the second buffer, the autonomous driving control apparatus may omit storing data corresponding to the overlapping period and may store only the new data 599 corresponding to a non-overlapping period in the storage device. For example, the new data 599 may be data, which is collected for K hours from the 1-2nd time point t12 to the 2-2nd time point t22, from among the second data 552. The autonomous driving control apparatus may only update (or store) the new data 599 in a storage device (e.g., eMMC) based on the fact that the second trigger signal is identified.

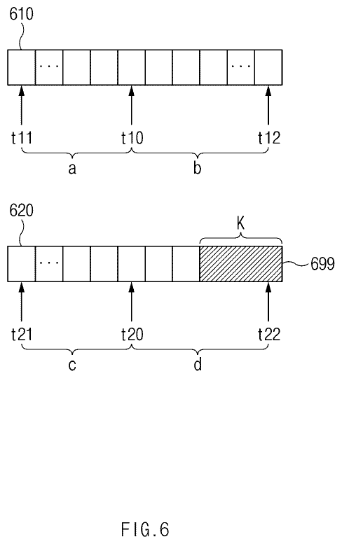

FIG. 6 is a conceptual diagram of operations of an autonomous driving control method, according to an exemplary embodiment of the present disclosure.

According to an exemplary embodiment of the present disclosure, an autonomous driving control apparatus (e.g., the autonomous driving control apparatus in FIG. 1) may store first data in a first buffer 610, and may store second data in a second buffer 620.

For example, if a first trigger signal is identified, the autonomous driving control apparatus may identify the 1-1st time point t11 earlier than the first time point t10, at which the first trigger signal occurs, by time ‘a’ (e.g., 30 seconds), and the 1-2nd time point t12 later than the first time point t10 by time ‘b’ (e.g., 30 seconds). Afterward, the autonomous driving control apparatus may store first data from the 1-1st time point t11 to the 1-2nd time point t12 in a storage device (e.g., eMMC).

For example, if a second trigger signal is identified, the autonomous driving control apparatus may identify the 2-1st time point t21 earlier than the second time point t20, at which the second trigger signal occurs, by time ‘c’ (e.g., 30 seconds), and the 2-2nd time point t22 later than the second time point t20 by time ‘d’ (e.g., 30 seconds). Afterward, the autonomous driving control apparatus may store second data from the 2-1st time point t21 to the 2-2nd time point t22 in the storage device (e.g., eMMC).

For example, in a process of storing the second data in the second buffer 620, the autonomous driving control apparatus may not store overlapping data among the first data and the second data in the storage device.

For example, the autonomous driving control apparatus may not store, in the storage device, data corresponding to a period from the 2-1st time point (e.g., the 2-1st time point t21 in FIG. 5) to the 1-2nd time point (e.g., the 1-2nd time point t12 in FIG. 5) among the second data. The time of the corresponding period may be a total of K hours. Accordingly, the first data 551 and the second data 552 corresponding to the corresponding periods are the same as each other, and thus there may be no need to store the first data 551 and the second data 552 redundantly in the storage device.

Accordingly, if the second trigger signal is identified in a process of storing the second data in the second buffer 620, the autonomous driving control apparatus may omit storing data corresponding to the overlapping period and may store only new data 699 (e.g., the new data 599 in FIG. 5) corresponding to a non-overlapping period in the storage device. For example, the new data 699 may be data collected for K hours from the 1-2nd time point to the 2-2nd time point (e.g., the 2-2nd time point t22 in FIG. 5) among the second data. The autonomous driving control apparatus may only update (or store) the new data 699 in a storage device (e.g., eMMC) based on the fact that the second trigger signal is identified.

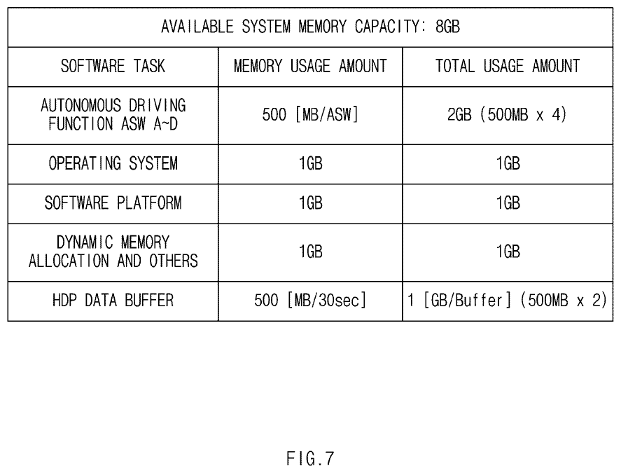

FIG. 7 is a table illustrating criteria used as an autonomous driving control apparatus utilizes an additional buffer, according to an exemplary embodiment of the present disclosure.

According to an exemplary embodiment of the present disclosure, an autonomous driving control apparatus (e.g., the autonomous driving control apparatus in FIG. 1) may temporarily store, based on two or more buffers, data regarding the driving of a host vehicle.

For example, the autonomous driving control apparatus may use two or more buffers based on specified criteria.

For example, referring to the table in FIG. 7, the autonomous driving control apparatus may identify that an available system memory capacity T is 8 GB.

For example, the autonomous driving control apparatus may identify that the memory usage amount of at least one application software layer (ASW) related to an autonomous driving function is 500 MB.

For example, the autonomous driving control apparatus may identify that there are four ASWs, and may identify that the total memory usage amount of at least one ASW related to the autonomous driving function is 2 GB.

For example, the autonomous driving control apparatus may identify that the memory usage amount used to use one operating system is 1 GB.

For example, the autonomous driving control apparatus may identify that the total memory usage amount ‘b’ used to use the operating system is 1 GB.

For example, the autonomous driving control apparatus may identify that the memory usage amount used to use one software platform is 1 GB.

For example, the autonomous driving control apparatus may identify that the total memory usage amount ‘b’ used to use the software platform ‘c’ is 1 GB.

For example, an autonomous driving control apparatus may identify that the memory usage amount used to perform dynamic memory allocation and another operation is 1 GB.

For example, an autonomous driving control apparatus may identify that the total memory usage amount ‘d’ used to perform dynamic memory allocation and another operation is 1 GB.

For example, the autonomous driving control apparatus may identify that the size (or a memory usage amount) of a specific data buffer (e.g., highway driving pilot (HDP) data buffer) is 500 MB/30 sec.

For example, the autonomous driving control apparatus may identify that the total size ‘e’ (or the total memory usage amount) of all specific data buffers is 1 GB/buffer.

Afterwards, the autonomous driving control apparatus may identify, based on at least part of the identified pieces of information, the number of available (or configurable) buffers. The autonomous driving control apparatus may identify the number of buffers based on Equation below.

Number of buffers=T−(a+b+c+d)/e [Equation 1]

The number of buffers according to the table in FIG. 7 may be 3. Accordingly, the autonomous driving control apparatus may sequentially store, based on three buffers, pieces of data identified while the host vehicle is driving. In other words, in FIG. 1, FIG. 2, FIG. 3, FIG. 4, FIG. 5 and FIG. 6 described above, it is assumed that the number of buffers is two. However, the autonomous driving control apparatus may perform data storage and management operations based on the number of buffers identified according to the table in FIG. 7.

FIG. 8 is a block diagram showing components of an autonomous driving control apparatus, according to an exemplary embodiment of the present disclosure.

According to an exemplary embodiment of the present disclosure, an autonomous driving control apparatus may store (e.g., the autonomous driving control apparatus in FIG. 1), based on a first storage device 811 (e.g., the first memory 212 or buffer in FIG. 2) and a second storage device 812 (e.g., the second memory 214 or eMMC in FIG. 2), pieces of data.

For example, the autonomous driving control apparatus may temporarily store first data 851 and second data 852 in a first buffer and a second buffer included in the first storage device 811, respectively.

For example, if a first trigger signal corresponding to the first data 851 is identified, the autonomous driving control apparatus may move and store the first data 851 from the 1-1st time point t11, which is earlier than the first time point t10 by time ‘a’, to the 1-2nd time point t12, which is later than the first time point t10 by time ‘b’, to the second storage device 812.

For example, if a second trigger signal corresponding to the second data 852 is identified, the autonomous driving control apparatus may move and store the second data 852 from the 2-1st time point t21 to the 2-2nd time point t22 to the second storage device 812. In the instant case, the 2-1st time point t21 and the 2-2nd time point t22 are identified based on a method substantially the same as the storage method of the first data 851 described above.

If redundant data is identified in a process of storing the first data 851 to the second storage device 812 and then storing the second data 852 to the second storage device 812, the autonomous driving control apparatus may not store the redundant data in the second storage device 812. Referring to FIG. 8, the autonomous driving control apparatus may not store data, which corresponds to a third period from the 2-1st time point t21 to the 1-2nd time point t12, from among the second data 852 in the second storage device 812. The time of the corresponding period may be a total of K hours. Accordingly, the first data 851 and the second data 852 corresponding to the corresponding period are the same as each other, and thus there may be no need to store the first data 551 and the second data 552 redundantly in the second storage device 812.

For example, if the second trigger signal is identified in a process of storing the second data 852 in the second buffer, the autonomous driving control apparatus may omit storing data corresponding to the overlapping period and may store only new data 899 (e.g., the new data 599 in FIG. 5 and the new data 699 in FIG. 6) corresponding to a non-overlapping period in the second storage device 812.

For example, the autonomous driving control apparatus may implement and store the new data 899 in a form of a file system 891 (e.g., a RAM file system). For example, the file system 891 may include pieces of data included in the new data 899 and information (e.g., time information related to the third period) about a time during which the new data 899 was collected. For example, the autonomous driving control apparatus may set a file name of the file system 891 to time information related to the third period. In the present way, the autonomous driving control apparatus may rapidly identify a specific file system among a plurality of file systems.

For example, if the new data 899 needs to be stored to the second storage device 812 as the second trigger signal is identified, the autonomous driving control apparatus may copy and store the file system 891, which is stored in the first storage device 851 to correspond to the new data 899, to the second storage device 812. Therefore, based on the copied file system 892, information including the new data 899 may be updated (or stored) in the second storage device 812.

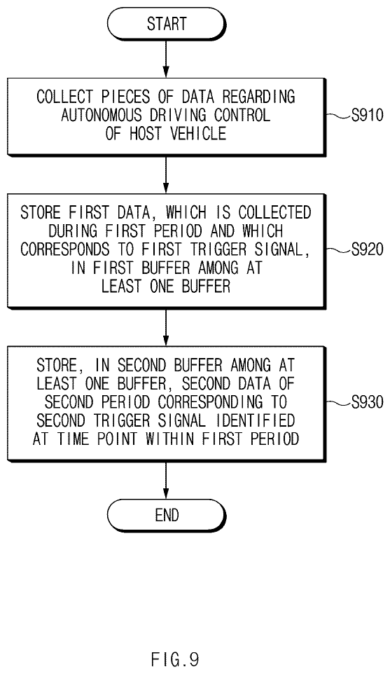

FIG. 9 is a flowchart of an autonomous driving control method, according to an exemplary embodiment of the present disclosure.

According to an exemplary embodiment of the present disclosure, an autonomous driving control apparatus (e.g., the autonomous driving control apparatus of FIG. 1) may perform operations described in FIG. 9. For example, at least some of components (e.g., the memory 110, and the control device 120 in FIG. 1) included in the autonomous driving control apparatus may be set to perform operations of FIG. 9.

In the following embodiment, S910 to S930 may be sequentially performed, but are not always performed sequentially. For example, the order of operations may be changed, and at least two operations may be performed in parallel. Moreover, descriptions corresponding to or identical to the above-mentioned descriptions provided with reference to FIG. 9 may be briefly described or omitted to avoid redundancy.

According to an exemplary embodiment of the present disclosure, the autonomous driving control apparatus may collect pieces of data regarding autonomous driving control of a host vehicle (S910).

According to an exemplary embodiment of the present disclosure, the autonomous driving control apparatus may store first data, which is collected during a first period and which corresponds to a first trigger signal, in a first buffer among the at least one buffer (S920).

According to an exemplary embodiment of the present disclosure, the autonomous driving control apparatus may store, in a second buffer among the at least one buffer, second data of a second period corresponding to a second trigger signal identified at a time point within the first period (S930).

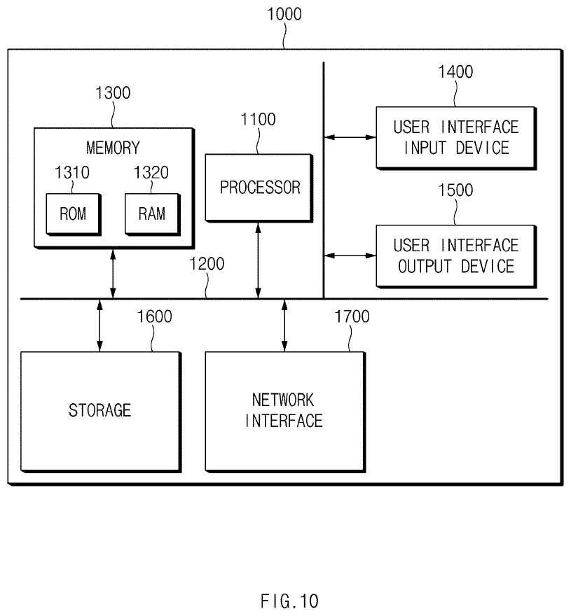

FIG. 10 shows a computing system related to an autonomous driving control apparatus or autonomous driving control method, according to an exemplary embodiment of the present disclosure.

Referring to FIG. 10, a computing system 1000 related to an autonomous driving control apparatus or an autonomous driving control method may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the exemplary embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one skilled in the art without departing from the essential characteristic of the present disclosure.

Accordingly, various exemplary embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of an autonomous driving control apparatus according to an exemplary embodiment of the present disclosure, and a method thereof are as follows.

Embodiments of the present disclosure, an autonomous driving control apparatus may sequentially store and manage data in at least one buffer included in a memory if data is continuously collected in a process of storing data regarding the driving of a host vehicle in the memory.

Embodiments of the present disclosure, an autonomous driving control apparatus may store first data among pieces of data in a first buffer, may exclude redundant data collected during a period that overlaps a first period corresponding to the first data, and may store (or update) only new data corresponding to the non-overlapping period in a second buffer.

Embodiments of the present disclosure, an autonomous driving control apparatus may store, based on a first thread, the first data, which is stored in the first buffer, in the storage device if the first trigger is identified. Embodiments of the present disclosure, an autonomous driving control apparatus may update, based on a second thread distinct from the first thread, new data, which is stored in the second buffer, in the storage device if a second trigger is identified.

Embodiments of the present disclosure, an autonomous driving control apparatus may store a RAM file system corresponding to new data in a buffer. Embodiments of the present disclosure, an autonomous driving control apparatus may copy the RAM file system to the storage device if identifying the second trigger signal.

Embodiments of the present disclosure, an autonomous driving control apparatus may rapidly copy at least part of data related to a trigger signal among pieces of data temporarily stored in the buffer to a storage device (e.g., eMMC).

Besides, a variety of effects directly or indirectly understood through the present disclosure may be provided.

Furthermore, the terms such as “unit”, “module”, etc. disclosed in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An autonomous driving control apparatus comprising:
a memory configured to store instructions and including at least one buffer and a storage device; and
a control device operatively connected to the memory,
wherein the instructions executed by the control device, cause the autonomous driving control apparatus to:
collect pieces of data regarding autonomous driving control of a host vehicle;
store first data, which is collected during a first period and which corresponds to a first trigger signal, in a first buffer among the at least one buffer; and
store, in a second buffer among the at least one buffer, second data of a second period corresponding to a second trigger signal identified at a time point within the first period.

2. The autonomous driving control apparatus of claim 1, wherein the instructions executed by the control device, further cause the autonomous driving control apparatus to:
collect the pieces of data including the first data and the second data while performing the autonomous driving control on the host vehicle in a predetermined driving section.

3. The autonomous driving control apparatus of claim 1, wherein the instructions executed by the control device, further cause the autonomous driving control apparatus to:
store the second data of the second period in the storage device, which is included in the memory and is separate from the at least one buffer, in response that the second trigger signal is identified.

4. The autonomous driving control apparatus of claim 1, wherein the storage device includes an embedded Multi-Media Card (eMMC).

5. The autonomous driving control apparatus of claim 4, wherein the instructions executed by the control device, further cause the autonomous driving control apparatus to:
update, in the second buffer, new data corresponding to a third period, which does not overlap the first period, in the second period from among the second data of the second period.

6. The autonomous driving control apparatus of claim 5, wherein the instructions executed by the control device, further cause the autonomous driving control apparatus to:
store, based on a first thread, the first data, which is stored in the first buffer, in the storage device in response that the first trigger is identified; and
update, based on a second thread distinct from the first thread, the new data, which is stored in the second buffer, in the storage device in response that the second trigger is identified.

7. The autonomous driving control apparatus of claim 6, wherein the instructions executed by the control device, further cause the autonomous driving control apparatus to:
store a RAM file system corresponding to the new data in the buffer; and
copy the RAM file system to the storage device in response of identifying the second trigger signal,
wherein the RAM file system includes at least one of driving data of the host vehicle corresponding to the third period among the second data, or time information related to the third period, or any combination thereof.

8. The autonomous driving control apparatus of claim 1, wherein the instructions executed by the control device, further cause the autonomous driving control apparatus to:
store predetermined data corresponding to a pre-defined event among the pieces of data in the storage device in response of identifying that the pre-defined event occurs while the pieces of data are collected.

9. The autonomous driving control apparatus of claim 8, wherein the pre-defined event includes at least one of:
activation or deactivation of at least part of an autonomous driving system of the host vehicle including the autonomous driving control apparatus;
occurrence of a situation of at least one of transition demand (TD), minimum risk maneuver (MRM), or emergency maneuver (EM), or any combination thereof;
data update of an event data recorder (EDR); or
occurrence of performance deterioration or failure of the host vehicle; or
any combination thereof.

10. The autonomous driving control apparatus of claim 1, wherein the instructions executed by the control device, further cause the autonomous driving control apparatus to:
encrypt at least one of location information of the host vehicle, or user information, or any combination thereof among the pieces of data and then store the encrypted result in the memory.

11. An autonomous driving control method, the method comprising:
collecting, by a control device, pieces of data regarding autonomous driving control of a host vehicle;
storing, by the control device, first data, which is collected during a first period and which corresponds to a first trigger signal, in a first buffer among at least one buffer; and
storing, by the control device, second data of a second period corresponding to a second trigger signal identified at a time point within the first period in a second buffer among the at least one buffer.

12. The method of claim 11, further including:
collecting, by the control device, the pieces of data including the first data and the second data while performing the autonomous driving control on the host vehicle in a predetermined driving section.

13. The method of claim 11, further including:
storing, by the control device, the second data of the second period in a storage device, which is included in a memory and is separate from the at least one buffer, in response that the second trigger signal is identified.

14. The method of claim 13, wherein the storage device includes an eMMC.

15. The method of claim 14, further including:
updating, by the control device, new data corresponding to a third period, which does not overlap the first period, in the second period from among the second data of the second period in the second buffer.

16. The method of claim 15, further including:
storing, based on a first thread, the first data, which is stored in the first buffer, in the storage device by the control device in response that the first trigger is identified; and
updating, based on a second thread distinct from the first thread, the new data, which is stored in the second buffer, in the storage device by the control device in response that the second trigger is identified.

17. The method of claim 16, further including:
storing, by the control device, a RAM file system corresponding to the new data in the buffer; and
copying, by the control device, the RAM file system to the storage device in response of identifying the second trigger signal,
wherein the RAM file system includes at least one of:
driving data of the host vehicle corresponding to the third period among the second data, or time information related to the third period, or any combination thereof.

18. The method of claim 13, further including:
storing, by the control device, predetermined data corresponding to a pre-defined event among the pieces of data in the storage device in response of identifying that the pre-defined event occurs while the pieces of data are collected.

19. The method of claim 18, wherein the pre-defined event includes at least one of:
activation or deactivation of at least part of an autonomous driving system of the host vehicle including an autonomous driving control apparatus;
occurrence of a situation of at least one of TD, MRM, or EM, or any combination thereof;
data update of an EDR; or
occurrence of performance deterioration or failure of the host vehicle; or
any combination thereof.

20. The method of claim 11, further including:
encrypting, by the control device, at least one of location information of the host vehicle, or user information, or any combination thereof among the pieces of data and then storing the encrypted result in a memory.
